(19) United States
(12) Patent Application Publication
(10) Pub. No.: US 2013/0133140 A1
(43) Pub. Date: May 30, 2013

(54) FABRIC CONDITIONING COMPOSITIONS

(71) Applicant: Tamara Marie Ross, Bebington (GB)

(72) Inventor: Tamara Marie Ross, Bebington (GB)

(21) Appl. No.: 13/698,681

(22) PCT Filed: May 20, 2011
(86) PCT No.: PCT/EP11/58272

§ 371 Date: Feb. 12, 2013

(30) Foreign Application Priority Data
May 25, 2010 (EP) 10163828.6

(51) Int. Cl. C11D 3/00

(52) U.S. Cl. CPC B05B 11/3015
USPC 8/137

(57) ABSTRACT

A packaged fabric conditioning product comprising the combination of a flowable fabric conditioning and a package containing the composition, the composition comprising 0.5-40% by weight of at least one unsaturated quaternary ammonium compound, and the package comprising: (i) a closed reservoir in which the fabric conditioning composition is contained; and (ii) a pump device by which the composition is dispensed.

The present invention relates to fabric conditioning compositions comprising unsaturated quaternary ammonium compounds and packaging therefore.

Quaternary ammonium compounds provide effective fabric conditioning agents. Unsaturated forms are particularly advantageous (as compared with saturated forms) due to the increased formulation flexibility offered. Unsaturated quaternary ammonium compounds allow more freedom in the selection of perfume within a fabric conditioning composition than their saturated counterparts. The unsaturated compounds are also cheaper.

However such unsaturated quaternary ammonium compounds suffer the disadvantage that they decompose (rancidify) when exposed to air with resultant discolouration and malodour.

Fabric conditioning liquid formulations are stored in bottles with screw-top lids. Each time these bottles are opened, the ullage (the air above the contained liquid), may be totally replaced so that a fresh supply of oxygen-rich air is supplied thereby exacerbating the rancidification process.

An object of the invention is therefore to provide a packaged fabric conditioning composition which offers formulation flexibility together with improved protection against rancidification.

Accordingly in a first aspect, the invention provides a packaged fabric conditioning product comprising the combination of a flowable fabric conditioning and a package containing the composition, the composition comprising 0.5-40% by weight of at least one unsaturated quaternary ammonium compound, and the package comprising:
(i) a closed reservoir in which the fabric conditioning composition is contained; and
(ii) a pump dispenser by which the composition is dispensed.

The fabric conditioner is preferably stored with ullage, such that dispensing increases the ullage only by addition of a volume equivalent to the volume of dispensed composition.

The term “ullage” as used herein, is intended to mean the volume (containing gas and/or vapour) above the flowable composition.

The ullage increases during use, as the composition is used up by the consumer. However, the invention is advantageous as the fabric conditioning formulation is dispensed without removal of a cap which would otherwise allow for complete refreshing by replacement of the ullage. Thus, dispensing of the fabric conditioning composition, via the dispensing device, results in egress of the composition followed by ingress of only that volume of air which is necessary to replace the volume of composition dispensed and equalise the pressure. There is no complete refreshing of the ullage. Thus, the amount of oxygen rich air which can contact and rancidify the composition is limited.

Preferably the pump dispenser is a non-aerosol device. Preferably the pump dispenser comprises a manually operated unidirectional reciprocated pump dispenser.

Preferably the pump dispenser device is enclosed by a closure device. The closure device may also provide a dispensing device with measurement indicia for measuring the dose of the composition and/or dispensing the measured dose in a washing machine.

The bottom dispensing container may comprise a polymeric material selected from polypropylene (PP), polyethylene (PE), polycarbonate (PC), polyamides (PA) polyethylene terephthalate (PET), polyvinylchloride (PVC), polystyrene (PS), and combinations thereof.

In a further aspect the invention provides a process for conditioning a fabric by treating the fabric with a flowable fabric conditioning composition comprising 0.5-40% by weight of at least one unsaturated quaternary ammonium compound using the product according to the first aspect, the process including the step of operating the pumping device to dispense the composition.

All percentages, unless indicated otherwise, are intended to be percentages by weight.

Compositions with higher levels of unsaturated quaternary ammonium compounds are more prone to such disadvantages. Accordingly the fabric conditioning composition preferably comprises 1-40% by weight, more preferably 15-40%, even more preferably 15-25% by weight of the unsaturated quaternary ammonium compound.

The fabric treatment composition of the invention is suitable for use in a laundry process. Examples include a softening-in-the-wash main wash composition, a rinse treatment (e.g. conditioner or finisher), or a post-treatment ‘wet tissue’ type product. The compositions of the present invention are preferably laundry compositions, especially softening-in-the-wash compositions or rinse-added softening compositions.

The compositions of the invention may be in any physical form e.g. a solid such as a powder or granules, a tablet, a solid bar, a paste, gel or liquid, especially, an aqueous based liquid, spray, stick, impregnated substrates, foam or mousse. In particular the compositions may be liquid, powder, or unit dose such as tablet laundry compositions.

The liquid products of the invention may have pH ranging from 2.5 (for fabric care compositions) to 12 (for fabric softening-in-the-wash compositions). This pH range preferably remains stable over the shelf life of the product.

The quaternary ammonium fabric softening material for use in compositions of the present invention can be an ester-linked triethanolamine (TEA) quaternary ammonium compound comprising a mixture of mono-, di- and tri-ester linked components.

Typically, TEA-based fabric softening compounds comprise a mixture of mono, di- and tri-ester forms of the compound where the di-ester linked component comprises no more than 70% by weight of the fabric softening compound, preferably no more than 60%, e.g. no more than 55%, or even no more than 45% of the fabric softening compound and at least 10% of the monoester linked component by weight of the fabric softening compound.

A first group of quaternary ammonium compounds (QACs) suitable for use in the present invention is represented by formula (I):

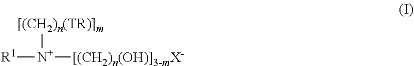

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO—O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are di-esters of triethanolamine methylsulphate, otherwise referred to as “TEA ester quats.”. Commercial examples include Prapagen TQ (ex Clariant), Tetranyl L1-90 (ex Kao), Stepantex VT-90 and VK-90 (ex Stepan), Rewoquat WE18 (ex Evonik) all di-[partially hardened tallow ester] of triethanolamine methylsulphate). Preferred are Au57 ex Cognis and Stepantex SP-90 both (di-[palm ester] of triethanolamine methylsulphate).

The second group of QACs suitable for use in the invention is represented by formula (II):

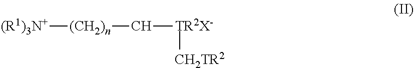

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above.

Preferred materials of this second group include 1,2 bis[tallowoyloxy]-3-trimethylamine propane chloride, 1,2 bis[hardened tallowoyloxy]-3-trimethylamine propane chloride, 1,2-bis[oleoyloxy]-3-trimethylamine propane chloride, and 1,2 bis[stearoyloxy]-3-trimethylamine propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof. A commercial example of this material is Armosoft DEQ (ex AKZO).

The iodine value of the quaternary ammonium fabric softening material is preferably from 20 to 60, more preferably from 20 to 40.

Iodine value is defined as the number of grams of iodine absorbed per 100 g of test material.

Iodine value as used in the context of the present invention refers to the measurement of the degree of unsaturation present in a material by a method of nmr spectroscopy as described in Anal. Chem., 34, 1136 (1962) Johnson and Shoolery.

Iodine value is defined as the number of grams of iodine absorbed per 100 g of the test material. Olefinic materials absorb 1 gram of iodine per atom of olefinic hydrogen. Hence measurement can be converted to the equivalent Iodine Value. The hydrogen nmr spectrum at 360 MHz is obtained for the test material. The integral intensity, Iₛ, of the band derived from olefinic hydrogen in the alkyl chain and the integral intensity, Iₘ, of the band derived from terminal methyl groups in the alkyl chains are measured.

The number of olefinic hydrogens per molecule is given by:

Iₛ×6

Iₘ

and the Iodine Value is given by:

$$\frac{{I}_{s} \times 127 \times 100 \times 6}{{I}_{m} \times MMW}$$

where MMW is the mean molecular weight of the test material.

The non-ester softening compound preferably has the alkyl or alkenyl chain lengths referred to above for the non-ester softening compound. One preferred type of non-ester softening compound is a quaternary ammonium material represented by formula (IV):—

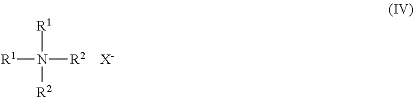

wherein each R¹ group is independently selected from C₁₋₄ alkyl, hydroxyalkyl or C₂₋₄ alkenyl groups; R² group is independently selected from C₈₋₂₈ alkyl or alkenyl groups, and X⁻ is as defined above.

The compositions may alternatively or additionally contain nonionic fabric softening agents such as lanolin and derivatives thereof. A further nonionic fabric softening agent suitable for use in the compositions of the invention is Castor oil, for example, from Now Chemicals.

Lecithins and other phospholipids are also suitable softening compounds. In fabric softening compositions nonionic stabilising agent may be present. Suitable nonionic stabilising agents may be present such as linear C₈ to C₂₂ alcohols alkoxylated with 10 to 20 moles of alkylene oxide, C₁₀ to C₂₀ alcohols, or mixtures thereof. Other stabilising agents include the deflocculating polymers as described in EP 0415698A2 and EP 0458599 B1.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

It is also possible to include certain mono-alkyl cationic surfactants which can be used in main-wash compositions for fabrics. Cationic surfactants that may be used include quaternary ammonium salts of the general formula R1R2R3R4N⁺X⁻ wherein the R groups are long or short hydrocarbon chains, typically alkyl, hydroxyalkyl or ethoxylated alkyl groups, and X is a counter-ion (for example, compounds in which R1 is a C8-C22 alkyl group, preferably a C8-C10 or C12-C14 alkyl group, R2 is a methyl group, and R3 and R4, which may be the same or different, are methyl or hydroxyethyl groups); and cationic esters (for example, choline esters).

Softening in the wash compositions in accordance with the invention comprise a surface-active compound, selected from anionic surfactants, cationic surfactants, non-ionic surfactants, zwitterionic surfactants, amphoteric surfactants and mixtures thereof. The choice of surface-active compound (surfactant), and the amount present, will depend on the intended use of the detergent composition. In fabric washing compositions, different surfactant systems may be chosen, as is well known to the skilled formulator, for handwashing products and for products intended for use in different types of washing machine.

The total amount of surfactant present will also depend on the intended end use and may be as high as 60 wt %, for example, in a composition for washing fabrics by hand. In compositions for machine washing of fabrics, an amount of from 5 to 40 wt % is generally appropriate. Typically the compositions will comprise at least 2 wt % surfactant e.g. 2-60%, preferably 15-40% most preferably 25-35%, by weight of the composition.

The fabric conditioning compositions of the invention can also contain adjuvants that are normal in the cosmetic, pharmaceutical and/or dermatological field, such as hydrophilic or lipophilic gelling agents, hydrophilic or lipophilic active agents, preserving agents, antioxidants, solvents, fragrances, fillers, screening agents, bactericides, odour absorbers, photobleaches (singlet oxygen or radical type) and dyestuffs. The amounts of these various adjuvants are those conventionally used in the field under consideration and are, for example, from 0.01 to 20% of the total weight of the composition. Depending on their nature, these adjuvants can be introduced into the fatty phase and/or into the aqueous phase. Examples of suitable biocides for use in the present invention include Proxel (1,2-benzisothiazolin-3-one), available from, for example, Univar, Avecia and Uniqema; and Kathon CG (Methylchloroisothiazolinone and Methylisothiazolinone), available from Rhom and Haas.

Various non-limiting embodiments of the invention will now be more particularly described with reference to the following figures in which:

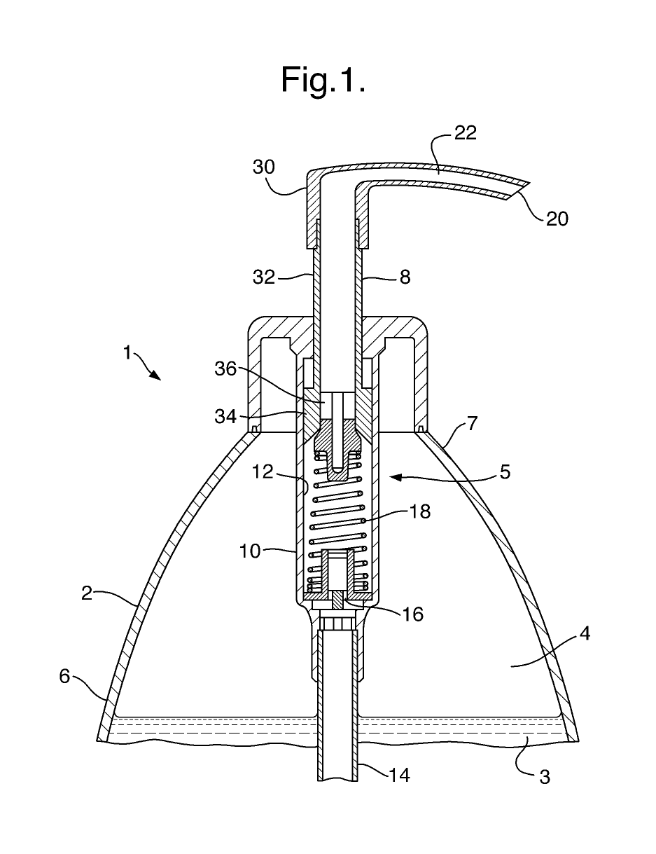

FIG. 1 shows an enlarged schematic view of a package according to the invention.

Referring to the drawings, a packaged fabric conditioning product 1 comprises a package 2 and composition 3 comprising unsaturated quaternary ammonium compounds according to any of the examples hereinbelow is shown, the composition stored with head space or ullage 4.

The package 2 comprises a closed reservoir 6 and a manually operated vertically reciprocated pump dispenser 5. Pump dispenser 5 comprises a pump housing 10 attached to an upper part of the closed reservoir 6 and extending into the interior thereof, together with a manually operated pump actuator 8 extending vertically downwardly into the pump housing 10 and at an opposed end, terminating in a dispensing head 30 with dispensing outlet 20.

The pump housing 10 includes a pump chamber 12 and a dip tube 14 extending downwardly into the pump chamber into the liquid. A one-way valve 16 is positioned between the pump chamber 12 and the dip tube 14 to control the unidirectional flow of liquid into the pump chamber 12 from the dip tube 14. The pump actuator 8 is mounted in the pump chamber 12 for vertical reciprocating movement. The pump actuator 8 has a bore extending therethrough and terminating at directional dispensing outlet 20.

A pump piston 34 is positioned inside the pump chamber, and at the base of the actuator. Coiled spring 18 longitudinally retained in the pump chamber engages against the bottom end of the pump actuator 8, biasing actuator and the piston 34 upwardly. A second one-way valve 36 is located in the pump plunger discharge passage adjacent the pump piston. The second valve permits only unidirectional flow of liquid in the direction from the pump chamber to the dispenser head 30 and outlet 20.

The pump dispenser 5 is actuated by manually depressing the pump actuator 8 downwardly which forces it into the pump housing 10, consequently the pump piston 34 moves downwardly through the pump chamber and compresses the fluid in the pump chamber 12. This causes the first one-way valve 16 to close and the second one-way valve 36 to open. The fluid in the pump chamber moves upwardly past the second one-way valve 36, along the actuator bore and dispensing passage 22 is dispensed from the dispensing outlet 20.

Releasing the actuator releases spring 18 to push the actuator upwardly relative to the pump housing 10. This moves the piston 34 upwardly through the pump chamber 12 so creating a vacuum which closes the second one-way valve 36 and opens the first one-way valve 16. This draws liquid from the container into the pump chamber 12, and the system is ready for acutation once again.

### NON-LIMITING EXAMPLES OF FABRIC CONDITIONING COMPOSITIONS ACCORDING TO EMBODIMENTS OF THE INVENTION AS DESCRIBED ABOVE

Unless stated otherwise, all proportions are given in weight percent by weight of the total composition.

### Exemplary: Fabric Conditioner Compositions 1, 2 and 3

| Composition | 1 | 2 | 3 |
|---|---|---|---|
| Softener | | | |
| Soft TEA Quat* | 16.5 | 10 | 16.5 |
| Fatty alcohol** | — | 0.5 | |
| Other components | | | |
| Electrolyte (CaCl2) | 0.015 | 0.015 | 0.015 |
| Perfume | 1.00 | 1.00 | 1.00 |
| Water | to 100 | to 100 | to 100 |

*Soft TEA quat is a cationic softener based on triethanolamine with tallow and 15% IPA as solvent. Compositions 1 and 2: (VT-90 ex Stepan) Composition 3: Soft DEEDMAC (Armosoft DEQ ex Akzo)
**C16C18 fatty alcohol (Hydrenol D ex Cognis)

It is of course to be understood that the invention is not intended to be restricted to the details of the above embodiment which are described by way of example only.

1. A packaged fabric conditioning product comprising the combination of a flowable fabric conditioning and a package containing the composition, the composition comprising 4.5-40% by weight of at least one unsaturated quaternary ammonium compound, and the package comprising:
(i) a closed reservoir in which the fabric conditioning composition is contained; and
(ii) a a pump dispenser by which the composition is dispensed.

2. A packaged fabric conditioning product according to claim 1 wherein the pump dispenser is enclosed by a closure device which also provides a dispensing device with measurement indicia for measuring the dose of the composition and/or dispensing the measured dose in a washing machine.

3. A packaged fabric conditioning product according to claim 1 wherein the at least one unsaturated quaternary ammonium compound comprises an ester-linked triethanolamine (TEA) quaternary ammonium compound comprising a mixture of mono-, di- and tri-ester linked components.

4. A packaged fabric conditioning product according to claim 1 wherein the iodine value of the quaternary ammonium fabric compound is from 20 to 60.

5. A process for conditioning a fabric using packaged fabric conditioning product according to claim 1, including the step of operating the pumping dispenser to dispense the composition.

6. A packaged fabric conditioning product substantially as hereinbefore described with reference to and/or as illustrated in the accompanying drawings.
